(19) United States
(12) Patent Application Publication
(10) Pub. No.: US 2010/0207729 A1
(43) Pub. Date: Aug. 19, 2010

(54) METHOD AND SYSTEM FOR TESTING RFID TAGS

(75) Inventors: Ming-Hsien Ko, Chiayi County (TW); Hui-Ta Chen, Taichung City (TW); Chuan-Sheng Zhuang, Taichung County (TW); Ching-Chih Lin, Kaohsiung City (TW); Chun-Hao Chang, Kaohsiung County (TW); Chih-Hung Kao, Changhua County (TW)

Correspondence Address: WPAT, PC;INTELLECTUAL PROPERTY ATTORNEYS, 7225 BEVERLY ST., ANNANDALE, VA, 22003, US

(73) Assignee: Industrial Technology Research Institute, Hsinchu (TW)

(21) Appl. No.: 12/575,077

(22) Filed: Oct. 7, 2009

(30) Foreign Application Priority Data
Feb. 13, 2009 (TW) 098104594

(51) Int. Cl. H04Q 5/22; B65G 43/08

(52) U.S. Cl. 340/10.1; 198/341.06

(57) ABSTRACT

The present invention provides a method and a system for testing RFID tags, which utilizes a way of adjusting the distance between the RFID tags and interrogator or adjusting the power of the interrogator accompanied with a shielding procedure for testing and classifying the RFID tags. By means of the method and the system of the present invention, it is capable of judging the efficacy and good and bad of the RFID tags, while the interrogatable distance of the RFID tags is capable of being tested effectively.

### FIELD OF THE INVENTION

The present invention relates to a technique for testing radio frequency identification (RFID) tags, and more particularly, to a method and system capable of testing and judging the efficacy of RFID tags by means of adjusting the distance between the RFID tags and their interrogator or adjusting the power of the interrogator.

### BACKGROUND OF THE INVENTION

Since 2004, the radio frequency identification (RFID) technology has become one of the top 10 breakthrough technologies of the century. The RFID technology has been widely used in, for example, logistics, inventory management, national securities, medical science and public health. The RFID technology using a reader, RFID tags and middleware and system integration is characterized in that the reader issues radio waves at a specific frequency to the RFID tags to drive the circuitry in the RFID tags to transmit the data in the chip back to the reader.

An RFID tag comprises an RF integrated circuit (RFIC) and an antenna. An RFID tag is packaged using an an-isotropic conductive paste (ACP) to agglutinate the substrate of the antenna so that the conductive particles in the an-isotropic conductive paste complete the electric circuit. The packaging quality depends on the packaging temperature, the packaging pressure and the packaging time. Therefore, automatized detection after packaging is crucial in quality control and yield improvement when mass production is concerned.

To improve the reliability of RFID tags and to prevent the distribution of RFID tags which do not function properly due to a manufacturing defect, it is desirable to test or screen each RFID tag during assembly. Consequently, the overall production efficiency is restricted by the performance of the devices used for testing RFID tags since the RFID testing devices that are currently available are comparatively not fast enough to match the speed of those used for assembling the RFID tags. Thus, most RFID tag manufacturers tend to arrange their RFID testing devices independent of the assembling devices outside their automated assembly line. However, such arrangement is going to cause an adverse result that the parameters relating to the assembling process can not be updated on time or immediately for improvement since the assembled RFID tags are not being tested immediately after they are packaged in the assembly line. Taking the RFID tag testing method and apparatus disclosed in U.S. Pat. No. 6,104,291 for example, the method employs an interrogation device with RF shield to read and test multiple tags in an each-by-each manner as the multiple tags are place sequentially on a conveyer belt in close proximity to each other, as shown in FIG. 1. Moreover, there is another prior-art RFID tag testing method disclosed in U.S. Pat. No. 7,187,293, as shown in FIG. 2. In FIG. 2, the prior-art testing method utilize a shield with suitable potential for allowing only the RFID tag which is being tested is placed within the read range of the test device during the test while enabling the RFID tags which are not being tested to be shielded and not activated.

### SUMMARY OF THE INVENTION

The present invention related to a method and a system for testing RFID tags, capable of integrating a RFID tag assembly process and a RFID tag testing process into one assembly line without suffering the disadvantages of other testing methods, such as time-consuming testing process, or difficult to implement, etc. Nevertheless, the RFID testing system can be arranged independent of the assembling devices outside the RFID assembly line and is capable of judging the efficacy and good and bad of the RFID tags in a rapid manner.

In an example embodiment, the present invention provides a method for testing RFID tags, which comprises the steps of: specifying a location within an interrogation field as the location is positioned a specific distance away from a plurality of RFID tags while performing an interrogation process upon the plural RFID tags; making an evaluation to determining whether there is any RFID tag in the plural RFID tags that is not interrogatable, and if there is, marking those interrogatable RFID tags in the plural RFID tags as interrogatable-grade tags of the specific distance and those not interrogatable as not-interrogatable-grade tags of the specific distance by the use of a shielding process; changing the specified location to another location in the interrogation field for changing the specific distance while performing the interrogation process upon the plural RFID tags; making an evaluation to determining whether there is any RFID tag in the plural RFID tags that is not interrogatable corresponding to the changed specific distance, and if there is, adding another interrogatable marking corresponding to the changed specific distance on those interrogatable RFID tags in the interrogatable-grade tags of the specific distance and the not-interrogatable-grade tags of the specific distance by the use of the shielding process, and similar adding another not-interrogatable marking corresponding to the changed specific distance on those not-interrogatable RFID tags in the interrogatable-grade tags of the specific distance and the not-interrogatable-grade tags of the specific distance also by the use of the shielding process.

In another example embodiment, the present invention provides a method for testing RFID tags, which comprises the steps of: applying an interrogation power for interrogating a plurality of RFID tags in an interrogation field; making an evaluation to determining whether there is any RFID tag in the plural RFID tags that is not interrogatable, and if there is, marking those interrogatable RFID tags in the plural RFID tags as interrogatable-grade tags of the specific interrogation power and those not interrogatable as not-interrogatable-grade tags of the specific interrogation power by the use of a shielding process; changing the specific interrogation power for interrogating the plural RFID tags; and making an evaluation to determining whether there is any RFID tag in the plural RFID tags that is not interrogatable corresponding to the changed specific interrogation power, and if there is, adding another interrogatable marking corresponding to the changed interrogation power on those interrogatable RFID tags in the interrogatable-grade tags of the specific interrogation power and the not-interrogatable-grade tags of the specific distance by the use of the shielding process, and similar adding another not-interrogatable marking corresponding to the changed interrogation power on those not-interrogatable RFID tags in the interrogatable-grade tags of the specific interrogation power and the not-interrogatable-grade tags of the specific interrogation power also by the use of the shielding process.

Yet, in another example embodiment, the present invention provides a system for testing RFID tags, which comprises: a conveyer belt section, having a conveyer belt configured therein to be used for carrying a plurality of RFID tags; an interrogation section, disposed at a side of the conveyer belt and capable of forming an interrogation field for reading data in the RFID tags of the plural RFID tags that are situated inside the interrogation field as they are being transported by the conveyer belt; a position adjusting section, for adjusting a distance between the conveyer belt and the interrogation section as it is coupled to the interrogation section; a shield section, for provide a specific shield to the plural RFID tags so as to define the amount of RFID tags capable of being interrogated by the interrogation section as the shield section is designed to be mobile for enabling the same to selectively shield at one RFID tag of the plural RFID tags; and a moving section, capable of enable the shield section to move by perform a displacement operation as it is coupled to the shield section.

Further, in another example embodiment, the present invention provides a system for testing RFID tags, which comprises: a conveyer belt section, having a conveyer belt configured therein to be used for carrying a plurality of RFID tags; an interrogation section with adjustable output interrogation power, disposed at a side of the conveyer belt and capable of forming an interrogation field according to its output interrogation power for enabling the RFID tags of the plural RFID tags, transported by the conveyer belt and thus entering into the interrogation field, to be interrogated; a shield section, for provide a specific shield to the plural RFID tags so as to define the amount of RFID tags capable of being interrogated by the interrogation section as the shield section is designed to be mobile for enabling the same to selectively shield at one RFID tag of the plural RFID tags; and a moving section, capable of enable the shield section to move by perform a displacement operation as it is coupled to the shield section.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 and FIG. 2 are schematic diagrams showing two prior-art RFID tag testing methods.

FIG. 3, composed of FIG. 3A and FIG. 3B, is a flow chart depicting steps of a method for testing RFID tag according to a first embodiment of the invention.

FIG. 4A to FIG. 4E are schematic diagrams respectively showing different actions performed in the testing method of FIG. 3.

FIG. 5, composed of FIG. 5A and FIG. 5B, is a flow chart depicting steps of a method for testing RFID tag according to a second embodiment of the invention.

FIG. 6A to FIG. 6D are schematic diagrams respectively showing different actions performed in the testing method of FIG. 5.

FIG. 7, composed of FIG. 7A and FIG. 7B, is a flow chart depicting steps of a method for testing RFID tag according to a third embodiment of the invention.

FIG. 8A to FIG. 8D are schematic diagrams respectively showing different actions performed in the testing method of FIG. 7.

FIG. 9, composed of FIG. 9A and FIG. 9B, is a flow chart depicting steps of a method for testing RFID tag according to a fourth embodiment of the invention.

FIG. 10A and FIG. 10B are schematic diagrams respectively showing different actions performed in the testing method of FIG. 9.

FIG. 11A is a schematic diagram showing a system for testing

RFID tags according to a first embodiment of the invention.

FIG. 11B is a schematic diagram showing a conveyer belt section used in the RFID testing system of the invention.

FIG. 12 is a schematic diagram showing a system for testing RFID tags according to a second embodiment of the invention.

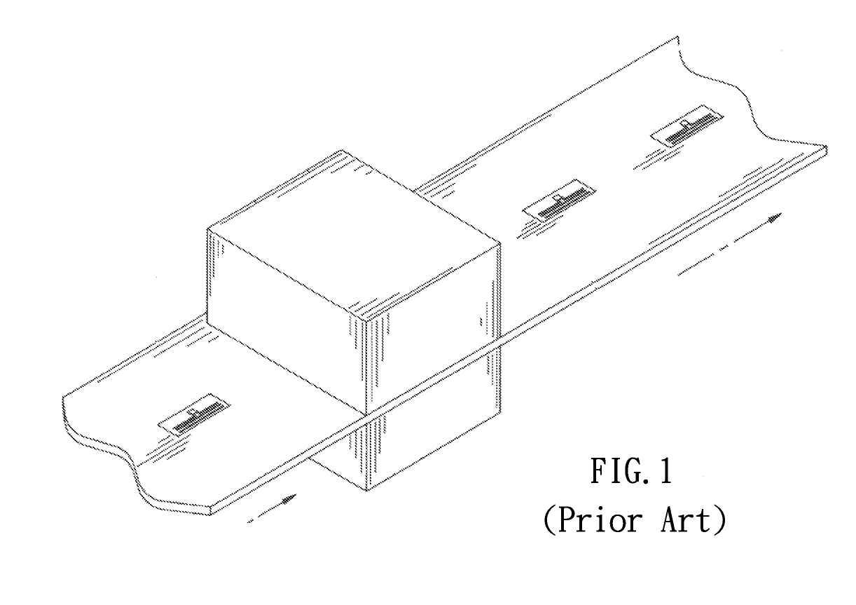

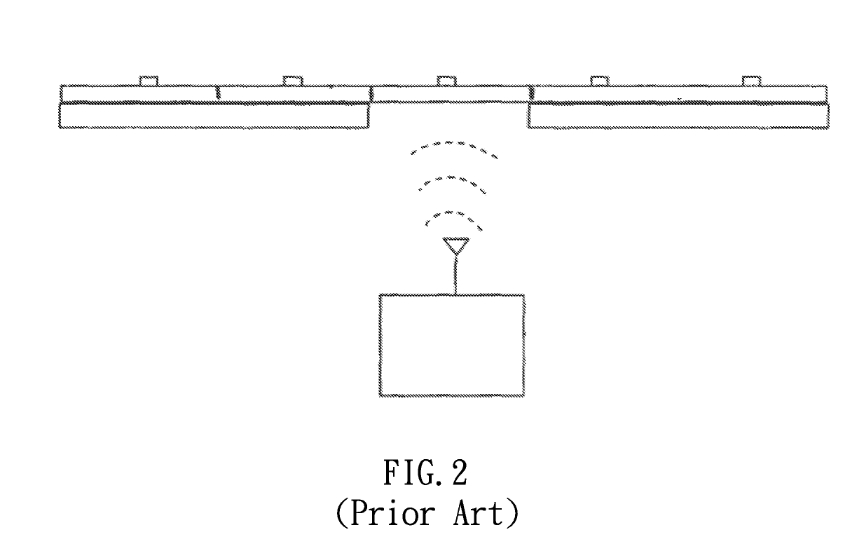

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

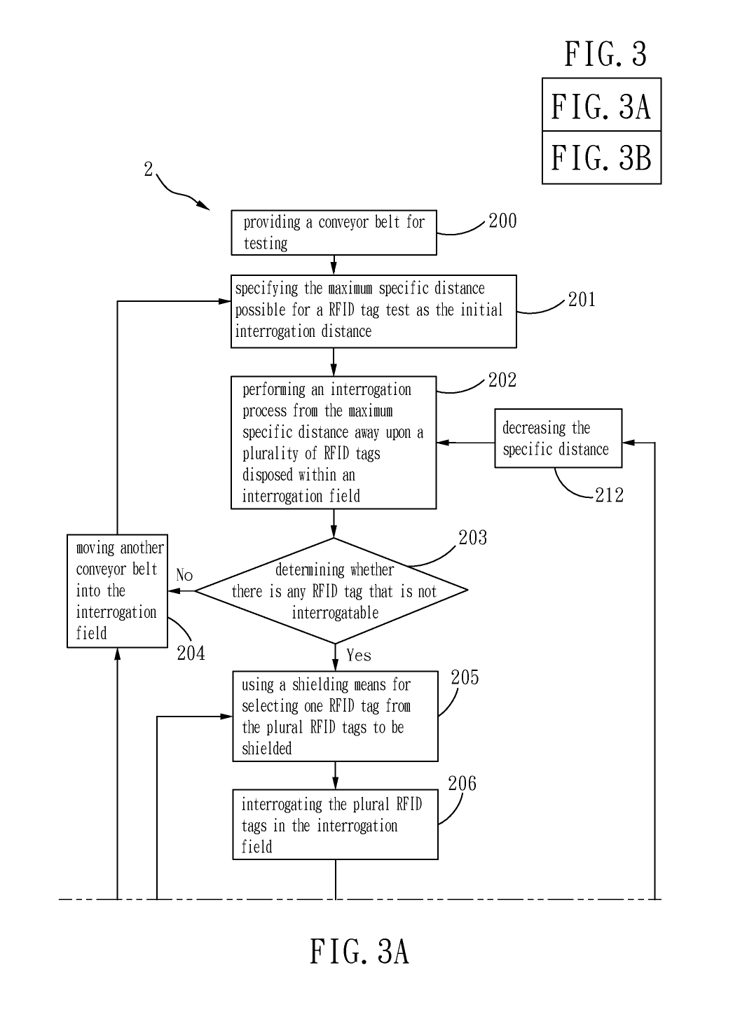

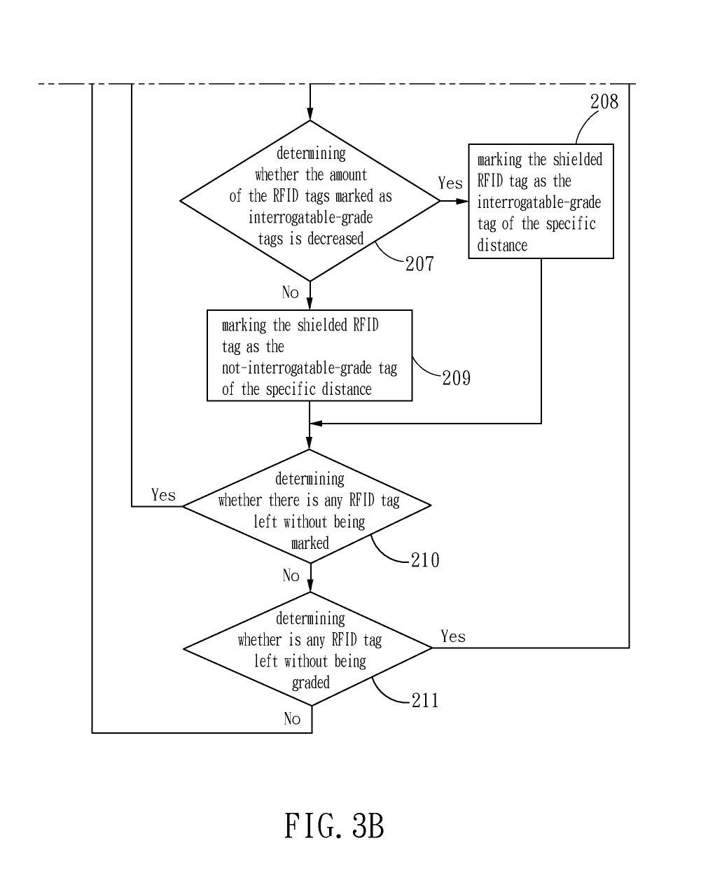

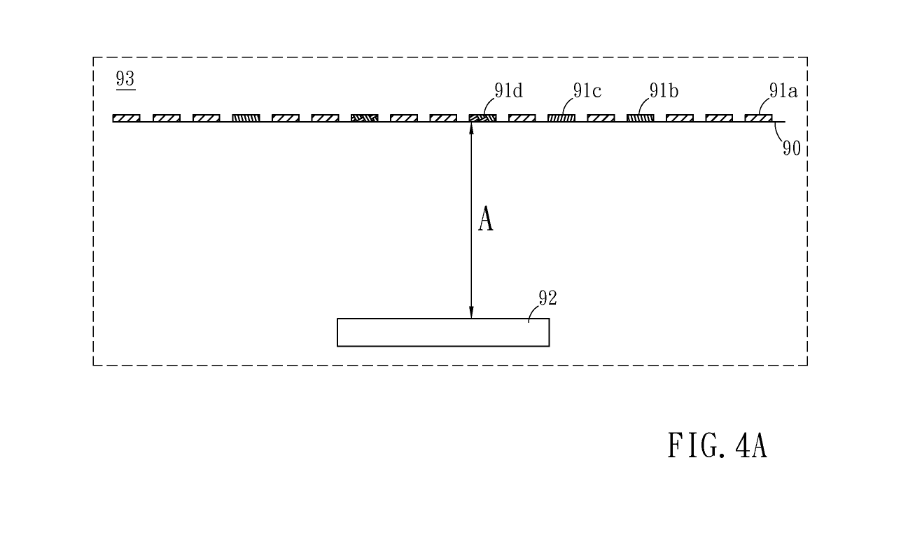

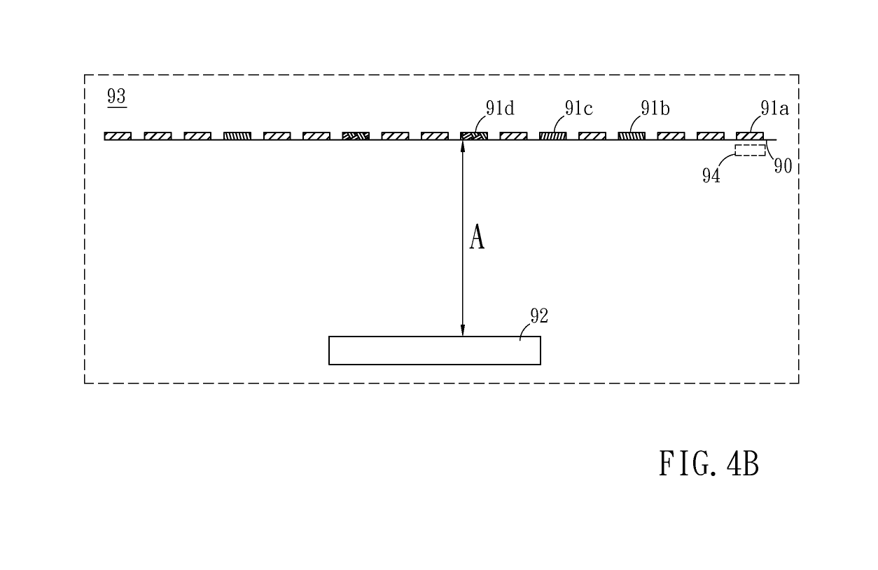

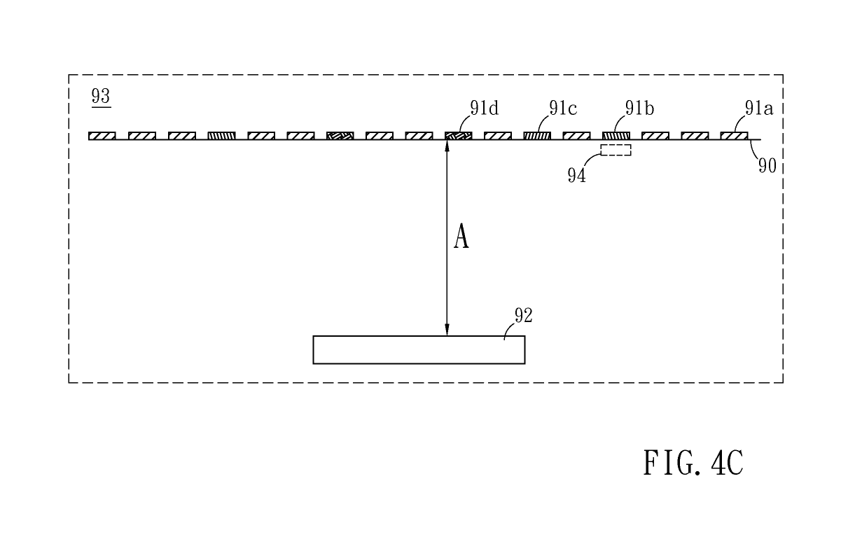

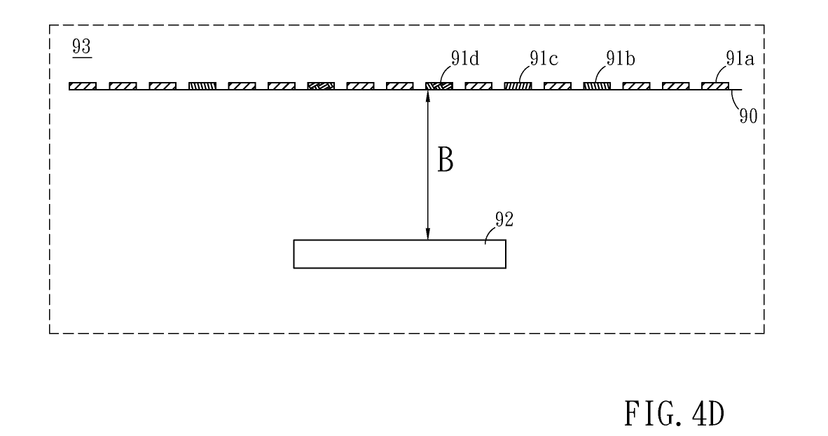

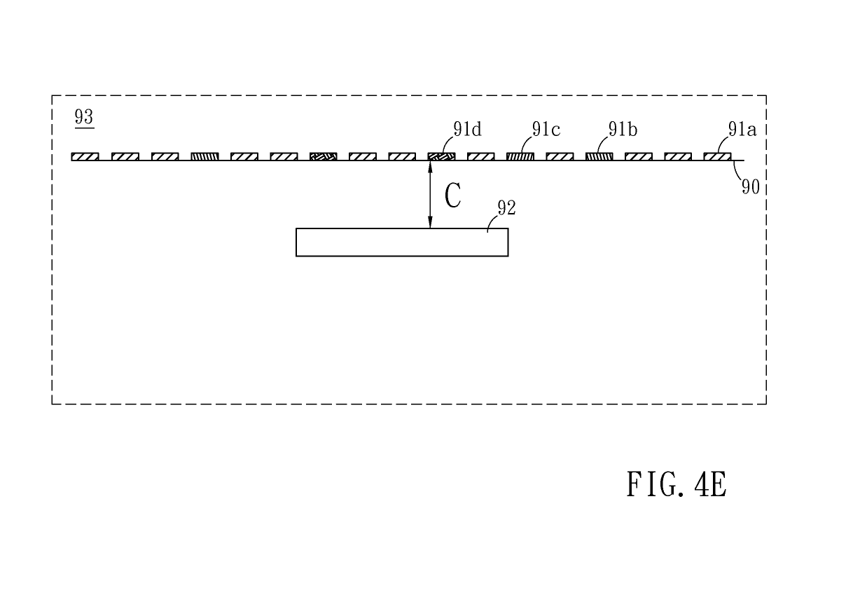

Please refer to FIG. 3, which is composed of FIG. 3A and FIG. 3B and is a flow chart depicting steps of a method for testing RFID tag according to a first embodiment of the invention. The flow chart 2 starts from the step 200. At step 200, a conveyor belt 90 for testing is provided, as shown in FIG. 4A; and then the flow proceeds to step 201. In FIG. 4A, there are a plurality of RFID tags 91a˜91d being disposed on the conveyor belt 90 for testing, in which the RFID tag 91a is a representative of “A-grade” RFID tags, the RFID tag 92 is a representative of “B-grade” RFID tags, and the RFID tag 91d is a representative of failed RFID tags. Moreover, the interrogator 92 capable of forming an interrogation field is disposed at a side of those RFID tags.

In this embodiment, each of the plural RFID tags are a smart tags, but is not limited thereby.

At step 201, the maximum specific distance A possible for a RFID tag test is specified as the initial interrogation distance; and then the flow proceeds to step 202. At step 202, an interrogation process is performed from the maximum specific distance A away upon a plurality of RFID tags disposed within an interrogation field; and then the flow proceeds to step 203 for evaluating the interrogation. At step 203, an evaluation is made for determining whether there is any RFID tag that is not interrogatable by determining whether the total amount of the RFID tags that are interrogatable is equal to the amount of the plural RFID tags; if so, then the flow proceeds to step 205; otherwise, since all the RFID tags currently in the interrogation field are all interrogatable in correspondence to the maximum specific distance A possible for the RFID tag test and thus they are all identified as the best “A-grade” tags, the flow will proceed to step 204 for enabling another batch of RFID tags to be brought into the interrogation field for interrogation. After another batch of RFID tags are moved into the interrogation field at step 204, the flow will proceeds back to step 201 for starting another interrogation process. However, if there are RFID tags that are not interrogatable according to the evaluation of the step 203, those not interrogatable RFID tags might not be the damaged goods that fail the RFID tag test completely, they can be the “B-grade” or even “C-grade” tags that simply can not be interrogated from the maximum specific distance A. It is noted that the grading used in this embodiment, i.e. A-grade, B-grade, C-grade and fail, is only for illustration and thus is not limited thereby.

For identifying exactly which RFID tags in the plural RFID tags are interrogatable, a shielding process is provided in the present invention which is designed to mark those interrogatable RFID tags in the plural RFID tags at a specific distance as interrogatable-grade tags of the specific distance and those not interrogatable as not-interrogatable-grade tags of the specific distance. In this embodiment, the shield process, as shown in FIG. 4B, is illustrated and performed in the step 205. At step 205, a shielding means 94 is used for selecting one RFID tag from the plural RFID tags to be shielded; and then the flow proceeds to step 206. At step 206, another interrogation process is performed upon the plural RFID tags in the interrogation field; and then the flow proceeds to step 207. At step 207, an evaluation is made for determining whether the amount of the RFID tags marked as interrogatable-grade tags is decreased by one; if so, then the flow proceeds to step 208 for marking the shielded RFID tag as the interrogatable-grade tag of the specific distance; otherwise, the flow proceeds to step 209 for marking the shielded RFID tag as the not-interrogatable-grade tag of the specific distance. It is noted that as the specific distance is the maximum specific distance A, the one that is shielded and marked as the interrogatable-grade tag of the specific distance can be identified as the “A-grade” tag.

On the other hand, when the amount of the RFID tags marked as interrogatable-grade tags is not decreased, the one that is shielded is the one marked as the not-interrogatable-grade tag of the specific distance, as shown in FIG. 4C that the shielding means shields the tag 91b, that it might not simply be a “fail” tag and can be a “B-grade” or even “C-grade” tags that simply can not be interrogated from the maximum specific distance A. Thus, after completing the marking in the step 208 and step 209, the flow will proceed to step 210.

At step 210, a process is performed for determining whether there is any RFID tag left without being marked; if so, the flow proceeds back to step 205 for repeating the steps 206˜210; otherwise, the flow proceeds to step 211. At step 211, a process is performed for determining whether is any RFID tag left without being graded; if not, the flow proceeds back to step 204 for moving another batch of RFID tags into the interrogation field; otherwise, the flow proceeds to step 212. At step 212, the specific distance is decreased, as shown in FIG. 4D where the specific distance is decreased from the maximum specific distance A to a smaller specific distance B; and then the flow proceeds to step 202 for repeating the interrogation process. During the repeating of the interrogation, if the total amount of the interrogatable RFID tags is equal to the amount of the plural RFID tags, it represents that the RFID tags that can not be interrogatable at the maximum specific distance A are interrogatable at the smaller specific distance B and thus they can all be identified as the “B-grade” tags so that all the RFID tags of the current batch are graded and thus the flow will proceed to step 204 for moving another batch of RFID tags into the interrogation field for testing.

However, if the total amount of the interrogatable RFID tags is not equal to the amount of the plural RFID tags, it represents that there are “C-grade” or even “fail” RFID tags in the current batch of the RFID tags so that the flow will proceeds to the step 205 for performing the shielding process upon those RFID tags that can not be interrogatable at the maximum specific distance A but can be interrogatable at the smaller specific distance B, and thereby, identifying exactly which RFID tags are those that can be interrogatable at the smaller specific distance B so as to marked those as the “B-grade” tags. Similarly, after one RFID tag in those can not be interrogatable at the maximum specific distance A but can be interrogatable at the smaller specific distance B is selected to be shielded, the flow will proceeds to step 206. At step 206, another interrogation process is performed; and the flow proceeds to step 207. At step 207, an evaluation is performed for determining whether the amount of the RFID tags marked as interrogatable-grade tags is decreased by one; if so, then the flow proceeds to step 208 for marking the shielded RFID tag as the interrogatable-grade tag of the specific distance, i.e. the “B-grade” tag; otherwise, the flow proceeds to step 209 for marking the shielded RFID tag as the not-interrogatable-grade tag of the specific distance, i.e. it can be a “C-grade” tag or a “fail” tag. Thus, after completing the marking in the step 208 and step 209, the flow will proceed to step 210.

At this time in the step 210, the process is performed again for determining whether there is any RFID tag that can not be interrogatable at the maximum specific distance A but can be interrogatable at the smaller specific distance B, that are left without being processed by the shielding process; if so, the flow proceeds back to step 205 for repeating the steps 206˜210; otherwise, the flow proceeds to step 211. At step 211, the process is performed for determining whether is any RFID tag left without being graded; if not, the flow proceeds back to step 204 for moving another batch of RFID tags into the interrogation field; otherwise, the flow proceeds to step 212. At step 212, the specific distance B is decreased again, as shown in FIG. 4E where the specific distance is decreased from the specific distance B to a smaller specific distance C; and then the flow proceeds to step 202 for repeating the interrogation process. Similarly, after step 202, the flow proceeds to step 203 for determining whether the total amount of the RFID tags that are interrogatable is equal to the amount of the plural RFID tags; and if the total amount of the interrogatable RFID tags is equal to the amount of the plural RFID tags, it represents that the RFID tags that can not be interrogatable at the specific distance B are interrogatable at the smaller specific distance C and thus they can all be identified as the “C-grade” tags so that all the RFID tags of the current batch are graded and thus the flow will proceed to step 204.

However, if the total amount of the interrogatable RFID tags is not equal to the amount of the plural RFID tags, it represents that there are even “fail” RFID tags in the current batch of the RFID tags so that the flow will proceeds to the step 205 for performing the shielding process upon those RFID tags that can not be interrogatable at the specific distance B but can be interrogatable at the smaller specific distance C, and thereby, identifying exactly which RFID tags are those that can be interrogatable at the smaller specific distance C so as to marked those as the “C-grade” tags. Similarly, after one RFID tag in those can not be interrogatable at the specific distance B but can be interrogatable at the smaller specific distance C is selected to be shielded, the flow will proceeds to step 206. At step 206, another interrogation process is performed; and the flow proceeds to step 207. At step 207, an evaluation is performed for determining whether the amount of the RFID tags marked as interrogatable-grade tags is decreased by one; if so, then the flow proceeds to step 208 for marking the shielded RFID tag as the interrogatable-grade tag of the specific distance, i.e. the “C-grade” tag; otherwise, the flow proceeds to step 209 for marking the shielded RFID tag as the not-interrogatable-grade tag of the specific distance, i.e. it can be a “fail” tag. Thus, after completing the marking in the step 208 and step 209, the flow will proceed to step 210.

At this time in the step 210, the process is performed again for determining whether there is any RFID tag that can not be interrogatable at the specific distance B but can be interrogatable at the smaller specific distance C, that are left without being processed by the shielding process; if so, the flow proceeds back to step 205 for repeating the steps 206˜210;

otherwise, the flow proceeds to step 211. At step 211, the process is performed for determining whether is any RFID tag left without being graded; if not, the flow proceeds back to step 204 for moving another batch of RFID tags into the interrogation field; otherwise, the flow proceeds to step 212. At step 212, the specific distance C is decreased again. Since there are only four grades, i.e. A, B. C and Fail, are used in the present embodiment, there is no further decreasing in interrogation distance necessary so that the grading for the current batch of the RFID tags is completed and thus the flow will proceeds to step 204 to move another batch of RFID tag into the interrogation field for testing starting from the maximum specific distance A.

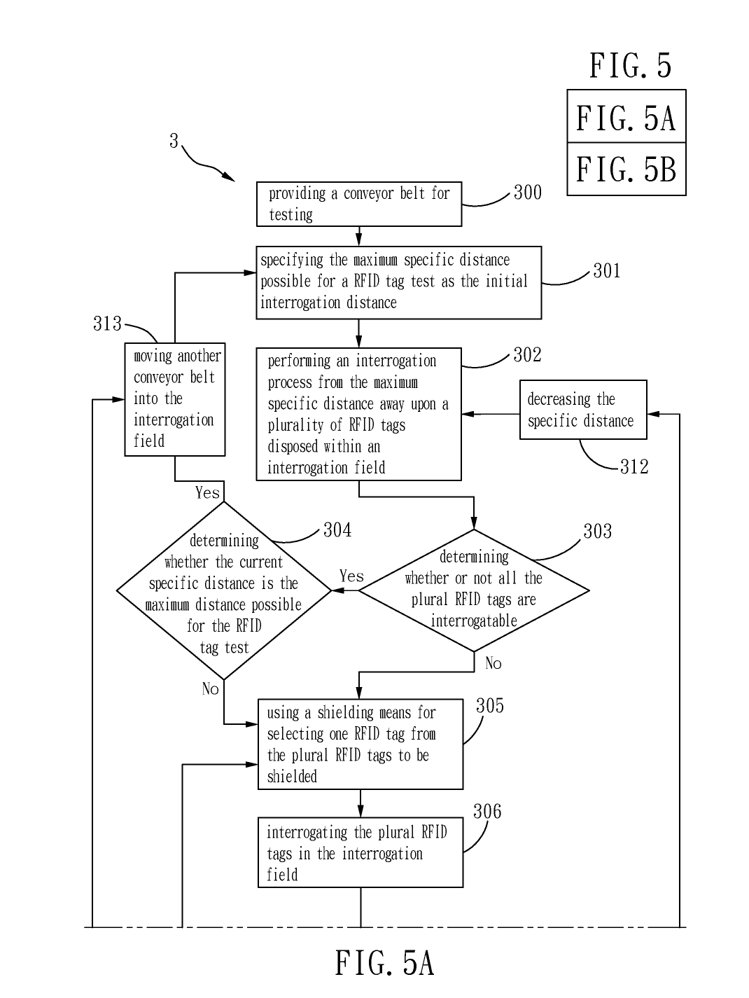

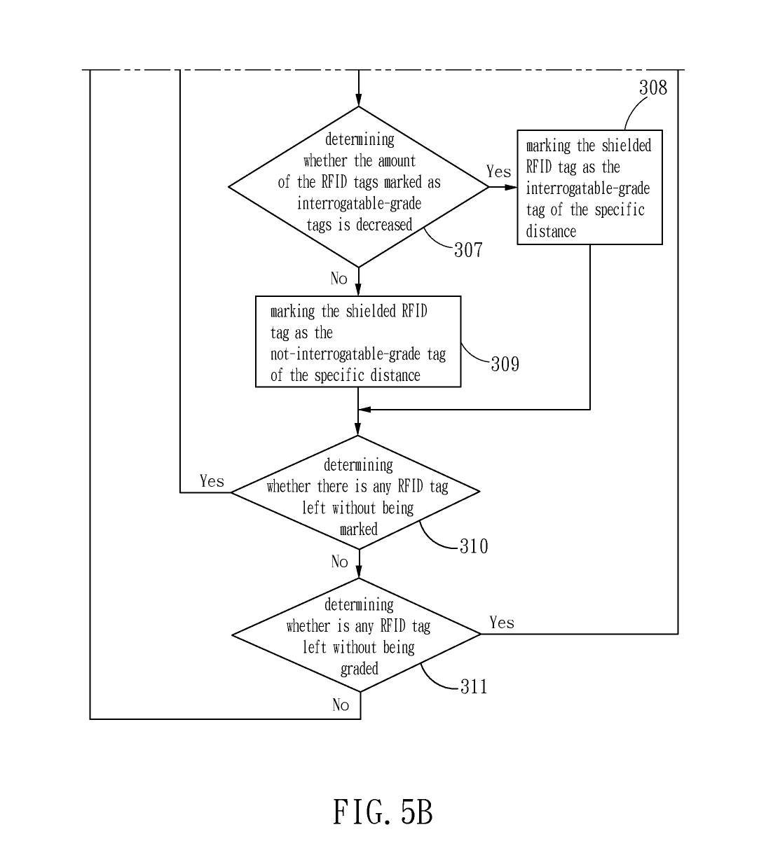

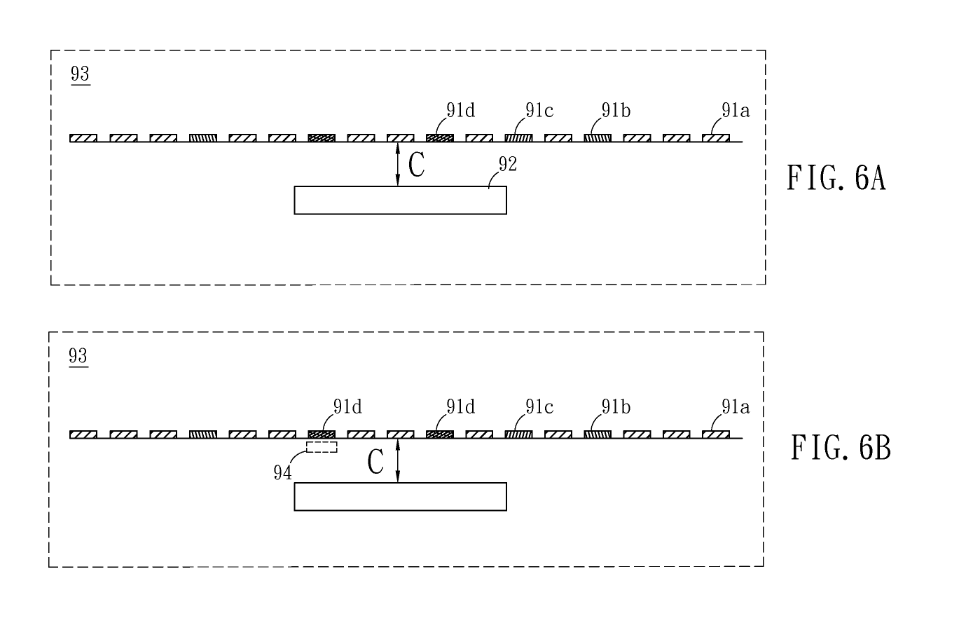

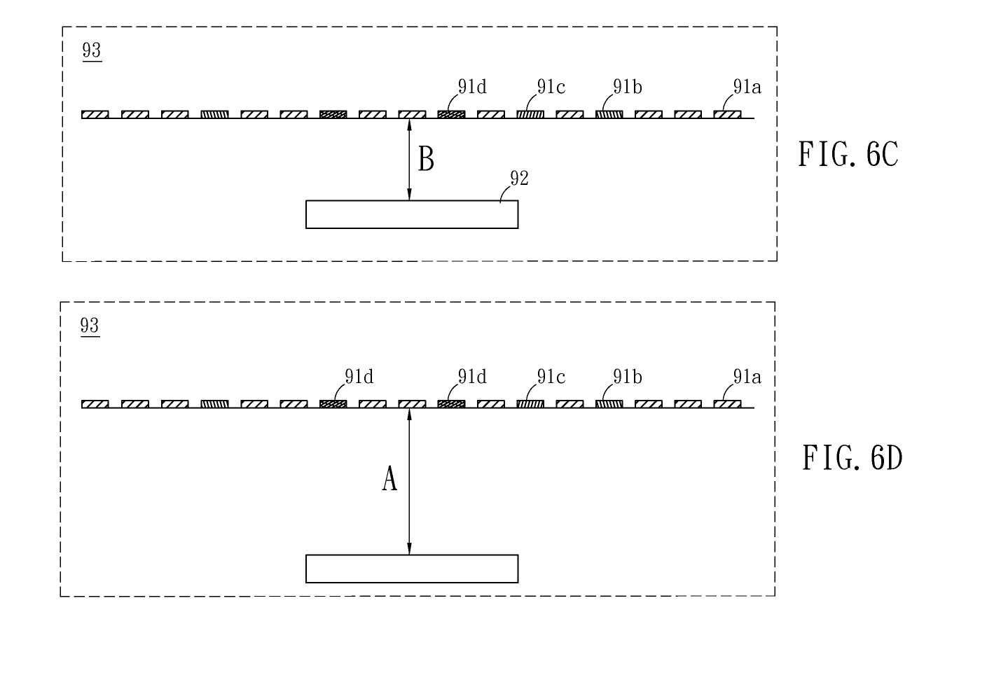

Please refer to FIG. 5, which is composed of FIG. 5A and FIG. 5B and is a flow chart depicting steps of a method for testing RFID tag according to a first embodiment of the invention. The flow 3 starts at step 300. At step 300, a conveyor belt for testing is provided; and then the flow proceeds to step 301. At step 301, the minimum specific distance C possible for a RFID tag test is specified as the initial interrogation distance, as shown in FIG. 6A; and then the flow proceeds to step 302. At step 302, an interrogation process is performed from the minimum specific distance C away upon a plurality of RFID tags disposed within an interrogation field; and then the flow proceeds to step 303 for evaluating the interrogation. At step 303, an evaluation is made for determining whether there is any RFID tag that is not interrogatable by determining whether the total amount of the RFID tags that are interrogatable is equal to the amount of the plural RFID tags; if so, then the flow proceeds to step 304 for determining whether the current distance C is equal to a maximum distance A. The step 304 is performed since all the RFID tags currently in the interrogation field are all interrogatable in correspondence to the minimum specific distance C possible for the RFID tag test and thus they can be “C-grade” tags, “B-grade” tag and even “A-grade” tag , it is required to perform the step 305 for determining whether the current specific distance is the maximum distance possible for the RFID tag test. At step 304, a process is performed for determining whether the current specific distance is the maximum distance possible for the RFID tag test; if so, the flow proceeds to step 313; otherwise, the flow proceeds to step 305 for performing a shielding process each by each on those currently identified as “C-grade” tags since there are RFID tags in those “C-grade” tags that are possible to be “B-grade” or even “A-grade” tags. After another batch of RFID tags are moved into the interrogation field at step 313, the flow will proceeds back to step 301 for starting another interrogation process. However, if there are RFID tags that are not interrogatable according to the evaluation of the step 303, those interrogatable RFID tags are identified as the “C-grade” tags while the amount of the “Fail” tags is equal to difference between the amount of the plural RFID tags and the amount of “C-grade” tags.

For identifying exactly which RFID tags in the plural RFID tags are interrogatable, a shielding process is provided in the present invention which is designed to mark those interrogatable RFID tags in the plural RFID tags at the minimum specific distance C as C-grade tags and those not interrogatable as not-interrogatable-grade tags of the minimum distance C as the “Fail” tags In this embodiment, the shield process, as shown in FIG. 6B, is illustrated and performed in the step 305. At step 305, a shielding means 94 is used for selecting one RFID tag from the plural RFID tags to be shielded; and then the flow proceeds to step 306. At step 306, another interrogation process is performed upon the plural RFID tags in the interrogation field; and then the flow proceeds to step 307. At step 307, an evaluation is made for determining whether the amount of the RFID tags marked as interrogatable-grade tags is decreased by one; if so, then the flow proceeds to step 308 for marking the shielded RFID tag as the interrogatable-grade tag of the specific distance, i.e. they can be C-grade, B-grade or even A-grade tags; otherwise, the flow proceeds to step 309 for marking the shielded RFID tag as the not-interrogatable-grade tag of the specific distance. It is noted that as the current specific distance is the minimum specific distance C, the one that is shielded and marked as the interrogatable-grade tag of the specific distance can be identified as the “Fail” tag. On the other hand, when the amount of the RFID tags marked as interrogatable-grade tags is not decreased, the one that is shielded is the one marked as the not-interrogatable-grade tag of the specific distance, as shown in FIG. 6B that the shielding means shields the tag 91b, that it might not simply be a “fail” tag and can be a “B-grade” or even “C-grade” tags that the amount of the RFID tags marked as interrogatable-grade tags is not decreased by one so that the current shielded RFID tag is identified as the “Fail” tag. Thus, after completing the marking in the step 308 and step 309, the flow will proceed to step 310.

At step 310, a process is performed for determining whether there is any RFID tag left without being marked; if so, the flow proceeds back to step 305 for repeating the steps 306˜310; otherwise, the flow proceeds to step 311. At step 311, a process is performed for determining whether is any RFID tag left without being graded; if not, the flow proceeds back to step 304 for moving another batch of RFID tags into the interrogation field; otherwise, the flow proceeds to step 312. At step 312, the specific distance is increased, as shown in FIG. 6C where the specific distance is increased from the minimum specific distance C to a larger specific distance B; and then the flow proceeds to step 302 for repeating the interrogation process. During the repeating of the interrogation, if the total amount of the interrogatable RFID tags is equal to the amount of the plural RFID tags, it represents that the RFID tags that can be interrogatable at the specific distance B are at least to be the “B-grade” tags.

However, if the total amount of the interrogatable RFID tags is not equal to the amount of the plural RFID tags, it represents that there are “C-grade” or even “fail” RFID tags in the current batch of the RFID tags so that the flow will proceeds to the step 305 for performing the shielding process upon those RFID tags that can be interrogatable at the minimum specific distance C for determining whether they are “B-grade” or “C-grade” tags since those “Fail” tags had already been identified by the previous steps, and thereby, identifying exactly which RFID tags are those that can be interrogatable at the larger specific distance B so as to marked those as the “B-grade” tags and those can not as the “C-grade” tags. Similarly, after one RFID tag in those interrogatable at the minimum specific distance C is selected to be shielded, the flow will proceeds to step 306. At step 306, another interrogation process is performed; and the flow proceeds to step 307. At step 307, an evaluation is performed for determining whether the amount of the RFID tags marked as interrogatable-grade tags of the specific distance B is decreased by one; if so, then the flow proceeds to step 308 for marking the shielded RFID tag as the interrogatable-grade tag of the specific distance B, i.e. the “B-grade” tag; otherwise, the flow proceeds to step 309 for marking the shielded RFID tag as the “C-grade” tag. Thus, after completing the marking in the step 308 and step 309, the flow will proceed to step 310.

At this time in the step 310, the process is performed again for determining whether there is any RFID tag that are left without being processed by the shielding process; if so, the flow proceeds back to step 305 for repeating the steps 306˜310; otherwise, the flow proceeds to step 311. At step 311, the process is performed for determining whether is any RFID tag left without being graded; if not, the flow proceeds back to step 313 for moving another batch of RFID tags into the interrogation field; otherwise, the flow proceeds to step 312. At step 312, the specific distance B is increased again, as shown in FIG. 6D where the specific distance is increased from the specific distance B to a larger specific distance A; and then the flow proceeds to step 302 for repeating the interrogation process. Similarly, after step 302, the flow proceeds to step 303 for determining whether the total amount of the RFID tags that are interrogatable is equal to the amount of the plural RFID tags; and if the total amount of the interrogatable RFID tags is equal to the amount of the plural RFID tags, the flow will proceed to step 304 for evaluating whether the current distance A is the maximum distance possible for the RFID tag test. If the distance A is the maximum distance possible, then the flow proceeds back to step 313.

However, if the total amount of the interrogatable RFID tags is not equal to the amount of the plural RFID tags, it represents that there are “B-grade” so that the flow will proceeds to the step 305 for performing the shielding process upon those RFID tags that can be interrogatable at the specific distance B for determining whether they are “B-grade” or “A-grade” tags since those “C-grade” and “Fail” tags had already been identified by the previous steps, and thereby, identifying exactly which RFID tags are those that can be interrogatable at the maximum specific distance A so as to marked those as the “A-grade” tags and those can not as the “B-grade” tags. Similarly, after one RFID tag in those interrogatable at the specific distance B is selected to be shielded, the flow will proceeds to step 306. At step 306, another interrogation process is performed; and the flow proceeds to step 307. At step 307, an evaluation is performed for determining whether the amount of the RFID tags marked as interrogatable-grade tags of the specific distance A is decreased by one; if so, then the flow proceeds to step 308 for marking the shielded RFID tag as the interrogatable-grade tag of the specific distance A, i.e. the “A-grade” tag; otherwise, the flow proceeds to step 309 for marking the shielded RFID tag as the “B-grade” tag. Thus, after completing the marking in the step 308 and step 309, the flow will proceed to step 310.

At this time in the step 310, the process is performed again for determining whether there is any RFID tag left without being processed by the shielding process; if so, the flow proceeds back to step 305 for repeating the steps 306˜210; otherwise, the flow proceeds to step 311. At step 311, the process is performed for determining whether is any RFID tag left without being graded; if not, the flow proceeds back to step 313 for moving another batch of RFID tags into the interrogation field; otherwise, the flow proceeds to step 312. At step 212, the specific distance is increased again. Since there are only four grades, i.e. A, B. C and Fail, are used in the present embodiment, there is no further increasing in interrogation distance necessary so that the grading for the current batch of the RFID tags is completed and thus the flow will proceeds to step 313 to move another batch of RFID tag into the interrogation field for testing starting from the minimum specific distance C.

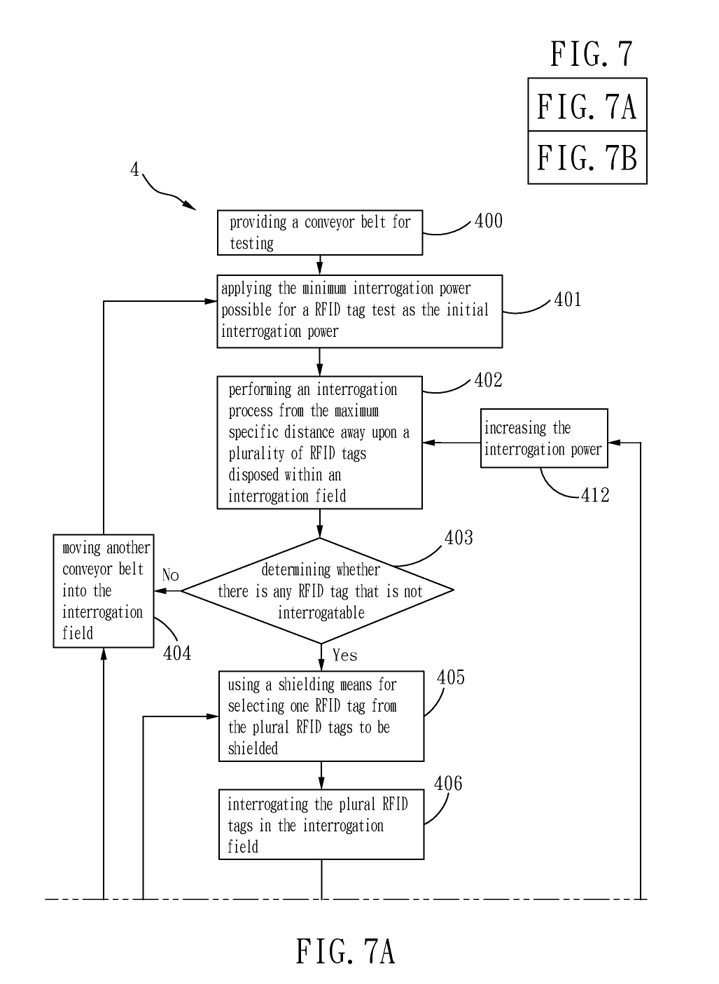

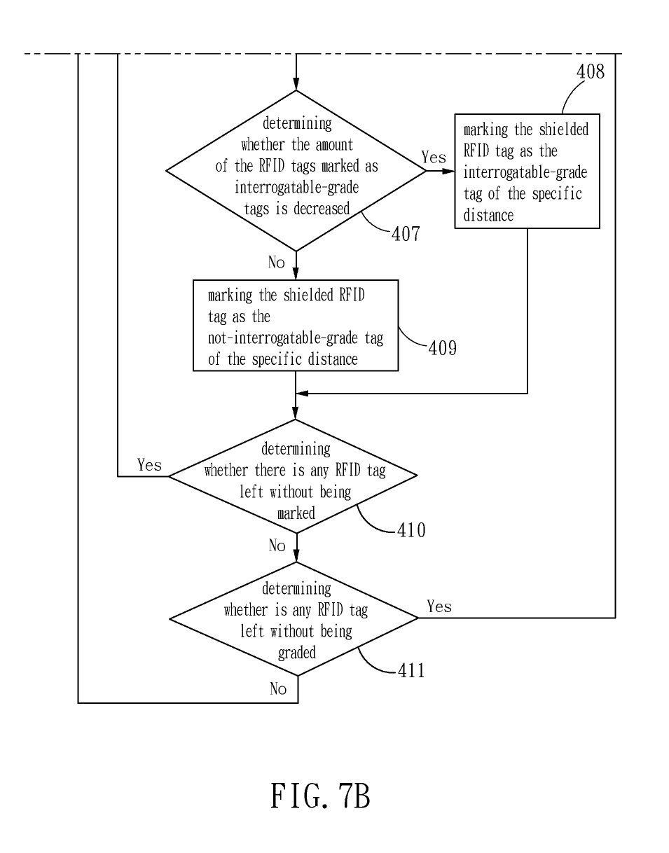

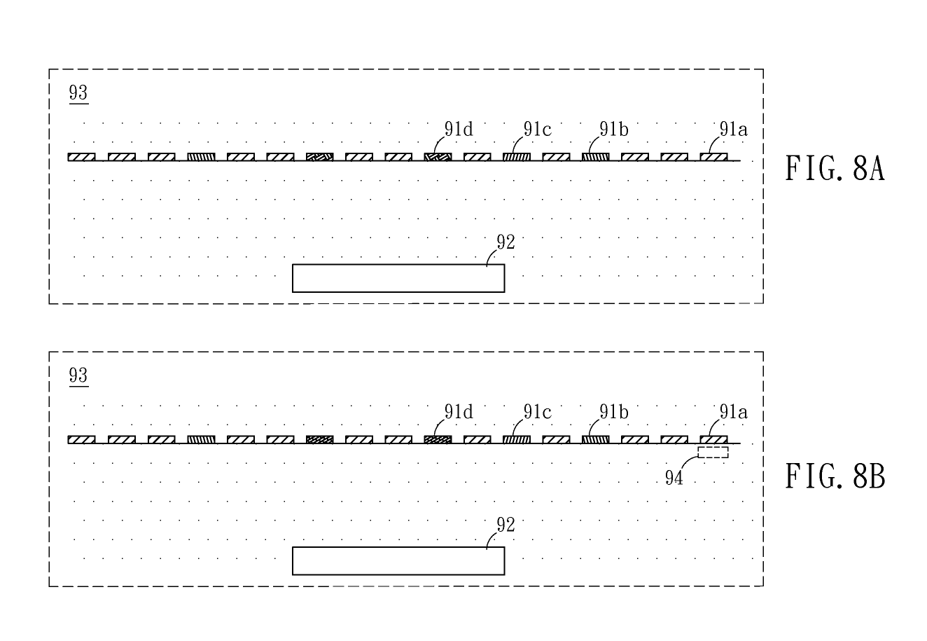

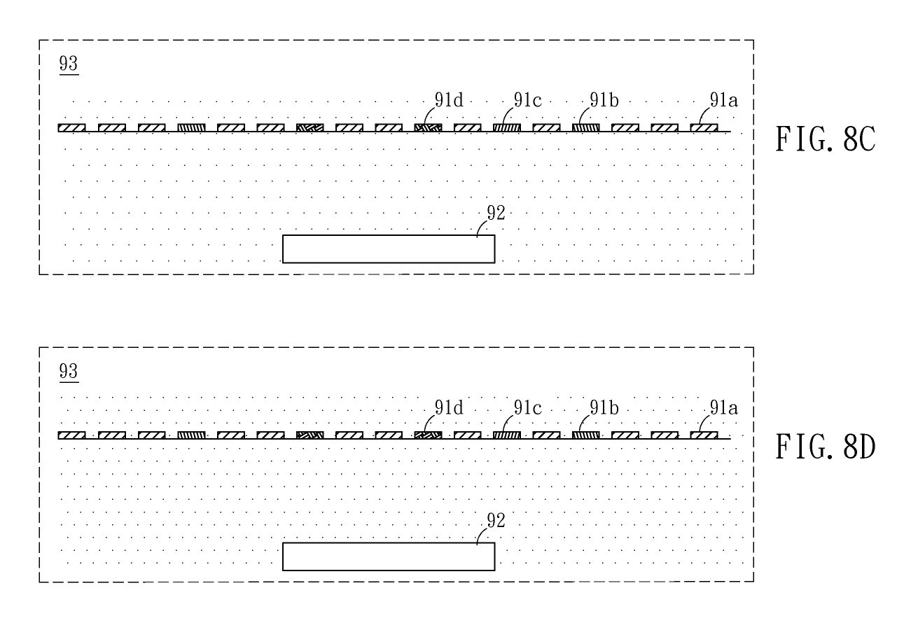

Please refer to FIG. 7, which is composed of FIG. 7A and FIG. 7B and is a flow chart depicting steps of a method for testing RFID tag according to a first embodiment of the invention. The flow chart 4 starts from the step 400. At step 400, a conveyor belt 90 for testing is provided, as shown in FIG. 8A; and then the flow proceeds to step 401. In FIG. 8A, there are a plurality of RFID tags 91a˜91d being disposed on the conveyor belt 90 for testing, in which the RFID tag 91a is a representative of “A-grade” RFID tags, the RFID tag 92 is a representative of “B-grade” RFID tags, and the RFID tag 91d is a representative of failed RFID tags. Moreover, the interrogator 92 capable of forming an interrogation field 93 is disposed at a side of those RFID tags. In this embodiment, each of the plural RFID tags are a smart tags, but is not limited thereby.

At step 401, the minimum interrogation power A db possible for a RFID tag test is specified as the initial interrogation power; and then the flow proceeds to step 402. At step 402, an interrogation process is performed upon a plurality of RFID tags using the minimum interrogation power A db as they are disposed within an interrogation field; and then the flow proceeds to step 403 for evaluating the interrogation. At step 403, an evaluation is made for determining whether there is any RFID tag that is not interrogatable by determining whether the total amount of the RFID tags that are interrogatable is equal to the amount of the plural RFID tags; if so, then the flow proceeds to step 405; otherwise, since all the RFID tags currently in the interrogation field are all interrogatable in correspondence to the minimum interrogation power A db for the RFID tag test and thus they are all identified as the best “A-grade” tags, the flow will proceed to step 404 for enabling another batch of RFID tags to be brought into the interrogation field for interrogation. After another batch of RFID tags are moved into the interrogation field at step 404, the flow will proceeds back to step 401 for starting another interrogation process. However, if there are RFID tags that are not interrogatable according to the evaluation of the step 403, those not interrogatable RFID tags might not be the damaged goods that fail the RFID tag test completely, they can be the “B-grade” or even “C-grade” tags that simply can not be interrogated by the minimum interrogation power A db, and the amount of such not-interrogatable RFID tags will equal to the different between the amount of the plural RFID tags and the amount of the RFID tags that are interrogatable using the minimum interrogation power A db.

For identifying exactly which RFID tags in the plural RFID tags are interrogatable, a shielding process is provided in the present invention which is designed to mark those interrogatable RFID tags in the plural RFID tags in correspondence to the minimum interrogation power as interrogatable-grade tags of the minimum interrogation power and those not interrogatable as not-interrogatable-grade tags of the minimum interrogation power. In this embodiment, the shield process, as shown in FIG. 8B, is illustrated and performed in the step 405. At step 405, a shielding means 94 is used for selecting one RFID tag from the plural RFID tags to be shielded; and then the flow proceeds to step 406. At step 406, another interrogation process is performed upon the plural RFID tags in the interrogation field; and then the flow proceeds to step 407. At step 407, an evaluation is made for determining whether the amount of the RFID tags marked as interrogatable-grade tags is decreased by one; if so, then the flow proceeds to step 408 for marking the shielded RFID tag as the interrogatable-grade tag of the minimum interrogation power, i.e. an “A-grade” tag; otherwise, the flow proceeds to step 409 for marking the shielded RFID tag as the not-interrogatable-grade tag of the minimum interrogation power. It is noted that as the current interrogation power is the minimum interrogation power A db, the one that is shielded and marked as the interrogatable-grade tag of the s the minimum interrogation power can be identified as the “A-grade” tag. On the other hand, when the amount of the RFID tags marked as interrogatable-grade tags is not decreased, the one that is shielded is the one marked as the not-interrogatable-grade tag of the minimum interrogation power, that it might not simply be a “fail” tag and can be a “B-grade” or even “C-grade” tags that simply can not be interrogated by the use of the minimum interrogation power A db. Thus, after completing the marking in the step 408 and step 409, the flow will proceed to step 410.

At step 410, the process is performed again for determining whether there is any RFID tag that are left without being processed by the shielding process; if so, the flow proceeds back to step 405 for selecting another such RFID tag to be shielded and then repeating the steps 406 410; otherwise, the flow proceeds to step 411. At step 411, the process is performed for determining whether is any RFID tag left without being graded; if not, the flow proceeds back to step 404 for moving another batch of RFID tags into the interrogation field; otherwise, the flow proceeds to step 412. At step 412, the interrogation power is increased, as shown in FIG. 6C, where the interrogation power is decreased from the minimum interrogation power A db to a smaller larger interrogation power B db; and then the flow proceeds to step 402 for repeating the interrogation process. Similarly, after step 402, the flow proceeds to step 403 for determining whether the total amount of the RFID tags that are interrogatable is equal to the amount of the plural RFID tags; and if the total amount of the interrogatable RFID tags is equal to the amount of the plural RFID tags, it represents that the RFID tags that can not be interrogatable using the minimum interrogation power A db are interrogatable using the larger interrogation power B db and thus they can all be identified as the “B-grade” tags so that all the RFID tags of the current batch are graded and thus the flow will proceed to step 404 for moving another batch of RFID tags into the interrogation field for testing.

However, if the total amount of the interrogatable RFID tags is not equal to the amount of the plural RFID tags, it represents that there are “C-grade” or even “fail” RFID tags in the current batch of the RFID tags so that the flow will proceeds to the step 405 for performing the shielding process upon those RFID tags that can not be interrogatable using the minimum interrogation power A db but can be interrogatable at the larger interrogation power B db, and thereby, identifying exactly which RFID tags are those that can be interrogatable using the larger interrogation power B db so as to marked those as the “B-grade” tags. Similarly, after one RFID tag in those can not be interrogatable using the minimum interrogation power A db but can be interrogatable a using the larger interrogation power B db is selected to be shielded, the flow will proceeds to step 406. At step 406, another interrogation process is performed; and the flow proceeds to step 407. At step 407, an evaluation is performed for determining whether the amount of the RFID tags marked as interrogatable-grade tags is decreased by one; if so, then the flow proceeds to step 408 for marking the shielded RFID tag as the interrogatable-grade tag of the larger interrogation power B db, i.e. the “B-grade” tag; otherwise, the flow proceeds to step 409 for marking the shielded RFID tag as the not-interrogatable-grade tag of the the larger interrogation power B db, i.e. it can be a “C-grade” tag or a “fail” tag. Thus, after completing the marking in the step 408 and step 409, the flow will proceed to step 410.

At this time in the step 410, the process is performed again for determining whether there is any RFID tag that can not be interrogatable left without being processed by the shielding process; if so, the flow proceeds back to step 405 for selecting another RFID tag to be shielded and then repeating the steps 406˜410; otherwise, the flow proceeds to step 411. At step 411, the process is performed for determining whether is any RFID tag left without being graded; if not, the flow proceeds back to step 404 for moving another batch of RFID tags into the interrogation field; otherwise, the flow proceeds to step 412. At step 412, the interrogation power is decreased again, as shown in FIG. 8D where the interrogation power is increased from the interrogation power B db to a larger interrogation power C db; and then the flow proceeds to step 402 for repeating the interrogation process. Similarly, after step 402, the flow proceeds to step 403 for determining whether the total amount of the RFID tags that are interrogatable is equal to the amount of the plural RFID tags; and if the total amount of the interrogatable RFID tags is equal to the amount of the plural RFID tags, it represents that the RFID tags that can not be interrogatable using the interrogation power B db are interrogatable at the larger interrogation power C db and thus they can all be identified as the “C-grade” tags so that all the RFID tags of the current batch are graded and thus the flow will proceed to step 404.

However, if the total amount of the interrogatable RFID tags is not equal to the amount of the plural RFID tags, it represents that there are “fail” RFID tags in the current batch of the RFID tags so that the flow will proceeds to the step 405 for performing the shielding process upon those RFID tags that can not be interrogatable at the interrogation power B db but can be interrogatable at the larger interrogation power C db, and thereby, identifying exactly which RFID tags are those that can be interrogatable using the larger interrogation power C db so as to marked those as the “C-grade” tags. Similarly, after one RFID tag in those can not be interrogatable at the interrogation power B db but can be interrogatable using the larger interrogation power C db is selected to be shielded, the flow will proceeds to step 406. At step 406, another interrogation process is performed; and the flow proceeds to step 407. At step 407, an evaluation is performed for determining whether the amount of the RFID tags marked as interrogatable-grade tags is decreased by one; if so, then the flow proceeds to step 408 for marking the shielded RFID tag as the interrogatable-grade tag of the interrogation power C db, i.e. the “C-grade” tag; otherwise, the flow proceeds to step 409 for marking the shielded RFID tag as the not-interrogatable-grade tag of the interrogation power C db, i.e. it can be a “fail” tag. Thus, after completing the marking in the step 408 and step 409, the flow will proceed to step 410, which is the same as those described hereinbefore and thus will not be described further.

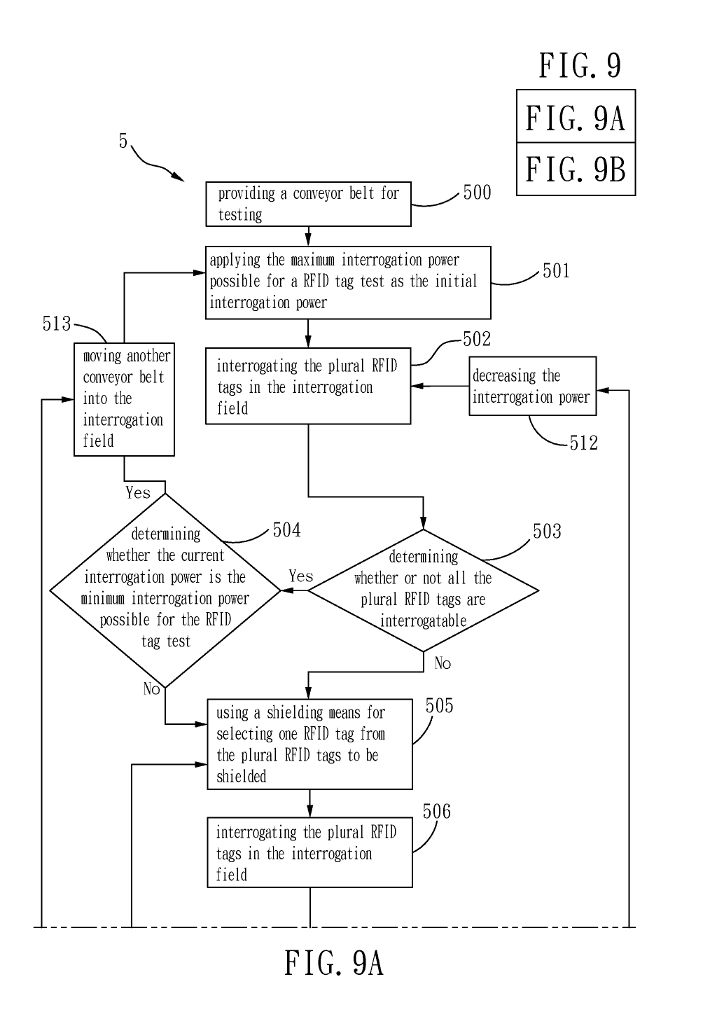

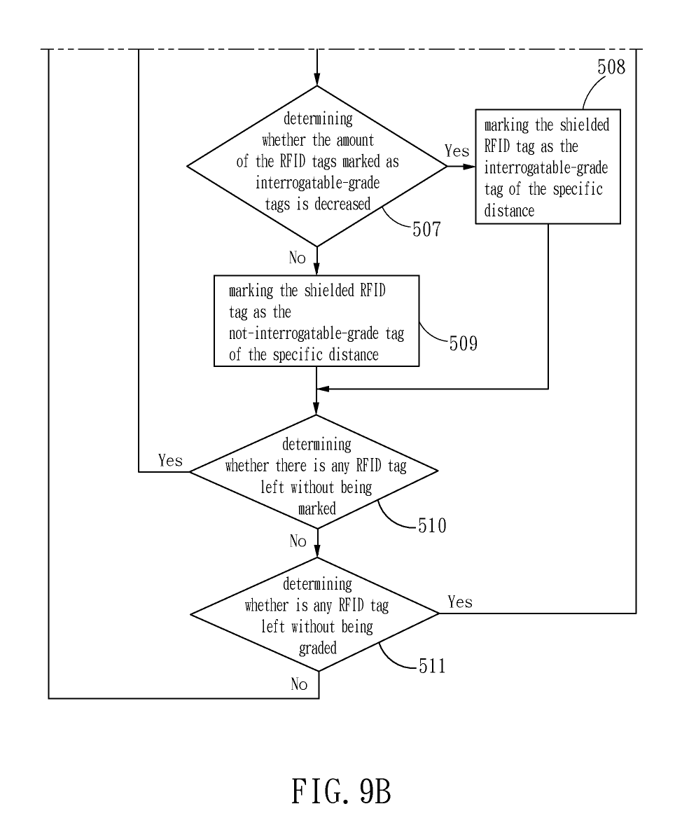

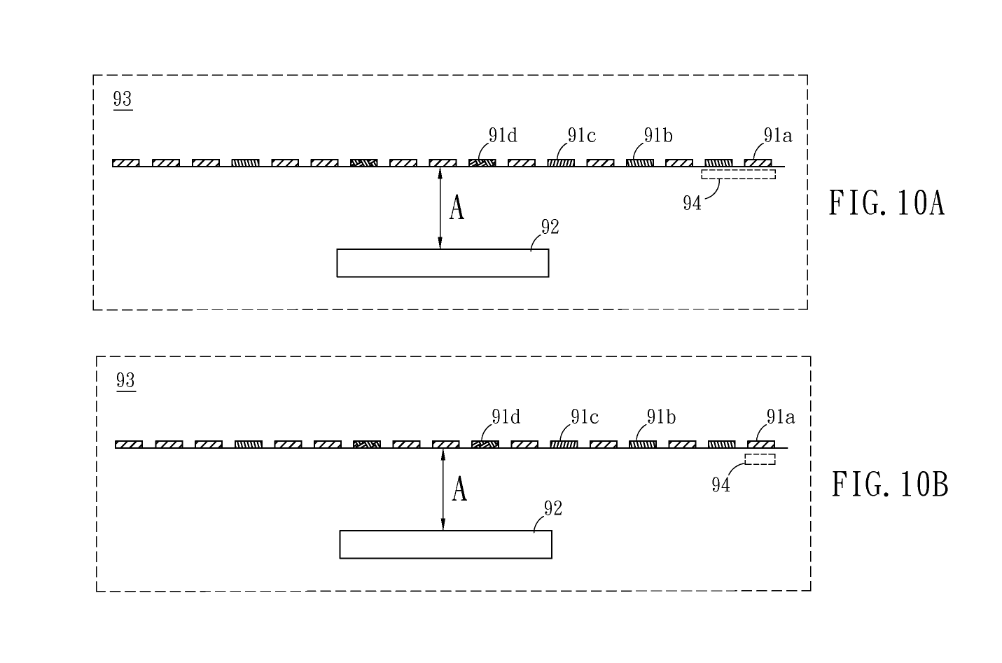

Please refer to FIG. 9, which is composed of FIG. 9A and FIG. 9B and is a flow chart depicting steps of a method for testing RFID tag according to a first embodiment of the invention. The step 500 to step 513 in the flow 5 shown in FIG. 9 is performed similar to those shown in FIG. 5, but instead of using the changing of specific distance for testing and grading the RFID tags, the present embodiment grading and testing the RFID tags by changing its interrogation power by gradually reducing the same from its maximum to its minimum. As the flow 5 of the present invention is similar to the aforesaid embodiments, it is not described further herein. Moreover, the shielding process performed in the present embodiment is different from those disclosed in the aforesaid embodiments. As shown in FIG. 10A and 10B, instead of shielding the RFIG tags in a one-by-one and each-by-each manner, the present embodiment will have more than one RFID tag to be shield in can evaluation so as to improve its testing efficiency.

As shown in FIG. 10A, there are two RFID tags in the interrogation field being selected and shielded. After the shielding, an interrogation process is performed upon those RFID tags in the interrogation field so as to evaluate whether the amount of previous-determined interrogatable RFID tags is decreased or not. If so but the amount of the decreasing is smaller than the number of the RFID tags selected to be shielded, identifying each of the two shielded RFID tags to be either one of the RFID tags being marked as the interrogatable-grade tags of the specific interrogation power or one of the RFID tags being marked as the not-interrogatable-grade tags of the specific interrogation power by reducing the area corresponding to the shielding in a stepwise manner. Taking the embodiments shown in FIG. 10A for example, if the amount of interrogatable RFID tags is decreased by two, it represents that the two shielded RFID tags are all “A-grade” tags. One the other hand, when the amount of the decreasing is smaller than 2 but larger then 0, the area corresponding to the shielding is reduced for enabling only one of the previous two shielded RFID tags to be shielded, as shown in FIG. 10B. After the area corresponding to the shielding is reduced, another interrogation process is performed, and if the amount of interrogatable RFID tags is decreased by one in this interrogation, the RFID tag that is currently shielded is a “A-grade” tag and thus another RFID tag of the two previous-selected RFID tags is not interrogatable corresponding to the current interrogation power, that is, it is not a “A-grade” tags, however it can be a “B-grade”, “C-grade” or “Fail” tag. Moreover, when the amount of interrogatable RFID tags is decreased at all, both of the two shielded RFID tags are not “A-grade” tag, but can only be “B-grade”, “C-grade” or “Fail” tags. It is noted that by shielding more than one RFID tags at a time, the testing efficiency of the RFID tag testing can be improved. In addition, the shielding of two RFID tags in the embodiment shown in FIG. 10A is only for illustration, the amount of RFID tags being shielded can be easily increased for those skilled in the art while there is not restriction regarding to the amount of RFID tags to be shielded at one.

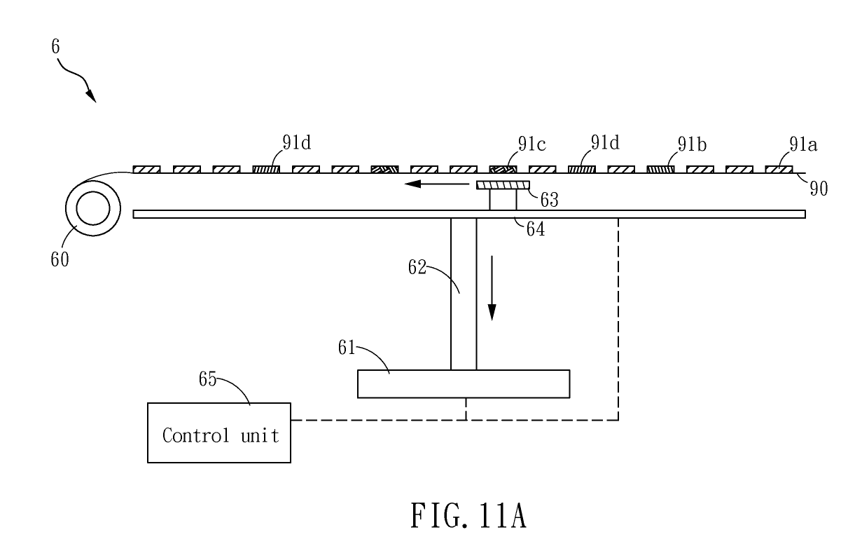

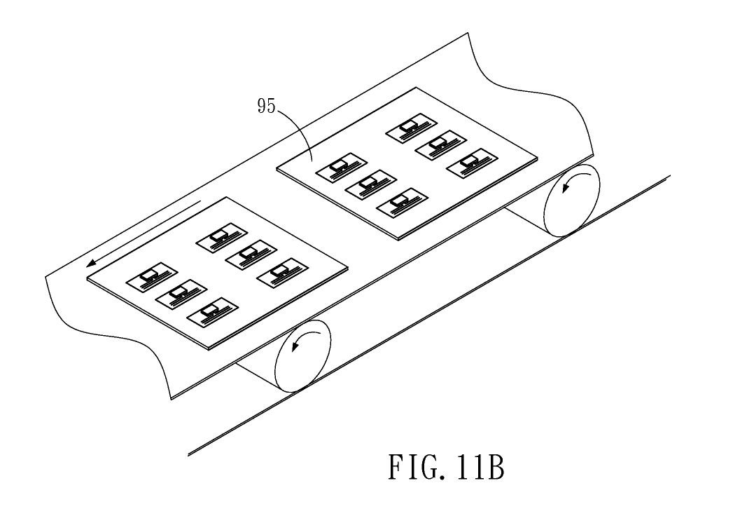

Please refer to FIG. 11A, which is a schematic diagram showing a system for testing RFID tags according to a first embodiment of the invention. The system for testing RFID tags 6 includes a conveyor belt section 60, an interrogation section 61, a position adjusting section 62, a shield section 63, a moving section 64 and a control unit 65. The conveyer belt section 60 has a conveyer belt 90 configured therein to be used for carrying a plurality of RFID tags 91a˜91d. In this embodiment, the conveyor belt section 60 is a roll-to-roll conveyor belt section, but it is not limited thereby. For instance, it can be a rectangle-shaped convey belt 95, i.e. a pallet being placed on a linear-moving transportation belt, as shown in FIG. 11B. Moreover, as shown in FIG. 11B, there can be more than one row of RFID tags being disposed on one rectangle-shaped convey belt 95 that there can be an array of RFID tags on the same rectangle-shaped convey belt 95. As the mechanism of the conveyor belt section 60 is known to those skilled in the art, it is not described further herein. The interrogation section 61 is disposed at a side of the conveyer belt 90 and capable of forming an interrogation field for reading data in the RFID tags of the plural RFID tags 91a˜91d that are situated inside the interrogation field as they are being transported by the conveyer belt 90. The position adjusting section 62 is used for adjusting a distance between the conveyer belt 90 and the interrogation section 60 as it is coupled to the interrogation section 60. In this embodiment, the position adjusting section 62 is a linear guide rail, but is not limited thereby.

The shield section 63 is used for provide a specific shield to the plural RFID tags 91a˜91d so as to define the amount of RFID tags capable of being interrogated by the interrogation section 61 as the shield section 63 is designed to be mobile for enabling the same to selectively shield at one RFID tag of the plural RFID tags 91a˜91d. The shield section 63 is made of a material selected from the group consisting of: a metal, a wave dissipating material, a wave absorbing material, a wave reflecting material and a wave impeding material. The moving section 64 is capable of performing a displacement operation for enabling the shield section 63 to move accordingly as it is coupled to the shield section 63. In this embodiment, the moving section 64 is a linear guide rail, but is not limited thereby. The control unit 65 is electrically connected with the interrogation section 61, the position adjusting section 62 and the moving section 64 that is capable of basing upon the flows shown in FIG. 3 and FIG. 5 to control the position adjusting section 61 to adjust the distance between the conveyer belt 90 and the interrogation section 61 and thus change the area capable of being interrogated by the interrogation section 61, while capable of basing upon the interrogation result of the interrogation section 61 to determine whether the amount of the RFID tags in the interrogation field marked as interrogatable-grade tags is decreased so as to control the moving of the shield section 63 for testing and grading the plural RFID tags.

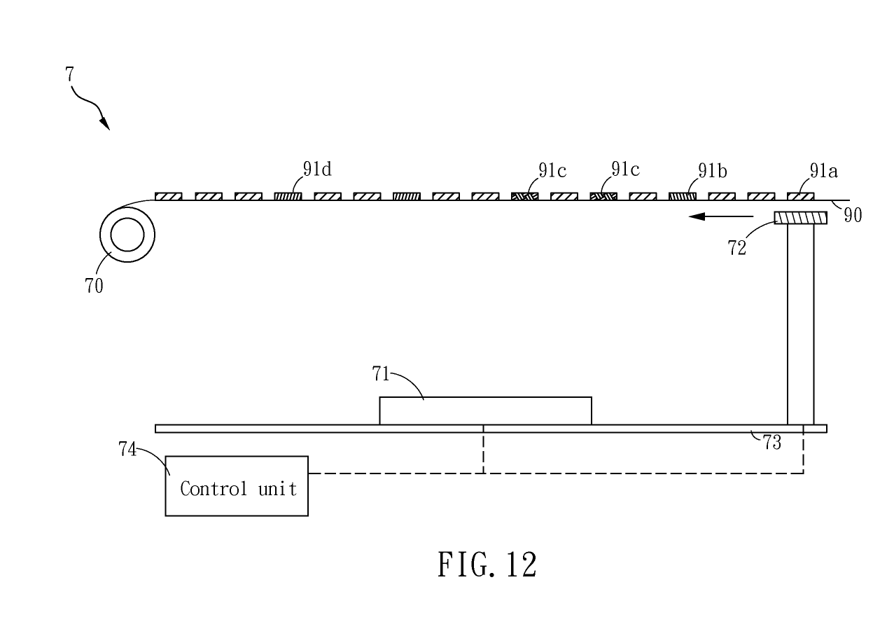

Please refer to FIG. 12, which is a schematic diagram showing a system for testing RFID tags according to a second embodiment of the invention. In the second embodiment, the system 7 includes a conveyor belt section 70, an interrogation section 71, a shield section 72, a moving section 73 and a control unit 74. The conveyor belt section 70, the shield section 72 and moving section 73 are all functioned the same as those described in the first embodiment, and thus are not described further herein. Nevertheless, the interrogation section 71 is designed with adjustable output interrogation power that is disposed at a side of the conveyer belt 90 and capable of forming an interrogation field according to its output interrogation power for enabling the RFID tags of the plural RFID tags, transported by the conveyer belt 90 and thus entering into the interrogation field, to be interrogated. The control unit 74, which is electrically connected with the interrogation section 71 and the moving section 73, is capable of controlling the changing of the interrogation power of the interrogation section 71 and thus change the area capable of being interrogated by the interrogation section 71, while capable of basing upon the interrogation result of the interrogation section to determine whether the amount of the RFID tags in the interrogation field marked as interrogatable-grade tags is decreased so as to control the moving of the shield section 72 for testing and grading the plural RFID tags.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for testing RFID tags, comprising the steps of:
(a) specifying a location within an interrogation field as the location is positioned a specific distance away from a plurality of RFID tags while performing an interrogation process upon the plural RFID tags;
(b) making an evaluation to determining whether there is any RFID tag in the plural RFID tags that is not interrogatable, and if there is, marking those interrogatable RFID tags in the plural RFID tags as interrogatable-grade tags of the specific distance and those not interrogatable as not-interrogatable-grade tags of the specific distance by the use of a shielding process;
(c) changing the specified location to another location in the interrogation field for changing the specific distance while performing the interrogation process upon the plural RFID tags; and
(d) making an evaluation to determining whether there is any RFID tag in the plural RFID tags that is not interrogatable corresponding to the changed specific distance, and if there is, adding another interrogatable marking corresponding to the changed specific distance on those interrogatable RFID tags in the changed specific distance selected from the interrogatable-grade tags of the specific distance and the not-interrogatable-grade tags of the specific distance by the use of the shielding process, and similar adding another not-interrogatable marking corresponding to the changed specific distance on those not-interrogatable RFID tags in the changed specific distance selected from the interrogatable-grade tags of the specific distance and the not-interrogatable-grade tags of the specific distance also by the use of the shielding process.

2. The method of claim 1, wherein the evaluation for determining whether there is any RFID tag in the plural RFID tags that is not interrogatable is performed by determining whether the total amount of the RFID tags that are interrogatable is equal to the amount of the plural RFID tags.

3. The method of claim 1, wherein each of the plural RFID tags is a smart tag.

4. The method of claim 1, wherein the shielding process further comprises the steps of:
selecting a RFID tag from the plural RFID tags that are situated inside the interrogation filed to be shielded;
performing an interrogation process upon the plural RFID tags inside the interrogation field for determining whether the amount of the RFID tags marked as interrogatable-grade tags is decreased; if so, identifying the shielded RFID tag to be one of the RFID tags being marked as the interrogatable-grade tags of the specific distance; otherwise, identifying the shielded RFID tag to be one of the RFID tags being marked as the not-interrogatable-grade tags of the specific distance; and
selecting another RFID tag from the plural RFID tags that are situated inside the interrogation filed to be shielded, and then repeating the previous determination process until the status of each and every one of the plural RFID tags are determined regarding to whether it is an interrogatable-grade tag of the specific distance, or is a not-interrogatable-grade tag of the specific distance.

5. The method of claim 1, wherein the shielding process further comprises the steps of:
selecting at least two RFID tags from the plural RFID tags that are situated inside the interrogation filed to be shielded;
performing an interrogation process upon the plural RFID tags inside the interrogation field for determining whether the amount of the RFID tags marked as interrogatable-grade tags is decreased; if so but the amount of the decreasing is smaller than the number of the RFID tags selected to be shielded, identifying each of the at least two shielded RFID tags to be either one of the RFID tags being marked as the interrogatable-grade tags of the specific distance or one of the RFID tags being marked as the not-interrogatable-grade tags of the specific distance by reducing the area corresponding to the shielding in a stepwise manner; and
selecting another at least two RFID tags from the plural RFID tags that are situated inside the interrogation filed to be shielded, and then repeating the previous determination process until the status of each and every one of the plural RFID tags are determined regarding to whether it is an interrogatable-grade tag of the specific distance, or is a not-interrogatable-grade tag of the specific distance.

6. The method of claim 1, wherein if the specific distance specified before the repeating is the maximum distance possible for testing the RFID tags, the RFID tags being marked as the not-interrogatable-grade tags of the specific distance in the step (b) are being added selectively and respectively by another interrogatable marking corresponding to the changed specific distance on those interrogatable RFID tags in the changed specific distance, or by the another not-interrogatable marking corresponding to the changed specific distance on those not interrogatable RFID tags in the changed specific distance, both according to the determinations in the repeating.

7. The method of claim 1, wherein if the specific distance specified before the repeating is the minimum distance possible for testing the RFID tags, the RFID tags being marked as the interrogatable-grade tags of the specific distance in the step (b) are being added selectively and respectively by another interrogatable marking corresponding to the changed specific distance on those interrogatable RFID tags in the changed specific distance, or by the another not-interrogatable marking corresponding to the changed specific distance on those not interrogatable RFID tags in the changed specific distance, both according to the determinations in the repeating.

8. The method of claim 1, wherein when each and every RFID tags within the interrogation field are determined to be interrogatable in the step (b), an evaluation is performed for determining whether the specific distance is the maximum distance possible for testing the RFID tags.

9. A method for testing RFID tags, comprising the steps of:
(a) applying a specific interrogation power for interrogating a plurality of RFID tags in an interrogation field;
(b) making an evaluation to determining whether there is any RFID tag in the plural RFID tags that is not interrogatable, and if there is, marking those interrogatable RFID tags in the plural RFID tags as interrogatable-grade tags of the specific interrogation power and those not interrogatable as not-interrogatable-grade tags of the specific interrogation power by the use of a shielding process;
(c) changing the specific interrogation power for interrogating the plural RFID tags; and
(d) making an evaluation to determining whether there is any RFID tag in the plural RFID tags that is not interrogatable corresponding to the changed specific interrogation power, and if there is, adding another interrogatable marking corresponding to the changed interrogation power on those interrogatable RFID tags in the changed specific distance selected from the interrogatable-grade tags of the specific interrogation power and the not-interrogatable-grade tags of the specific distance by the use of the shielding process, and similar adding another not-interrogatable marking corresponding to the changed interrogation power on those not-interrogatable RFID tags in the changed specific distance selected from the interrogatable-grade tags of the specific interrogation power and the not-interrogatable-grade tags of the specific interrogation power also by the use of the shielding process.

10. The method of claim 9, wherein the evaluation for determining whether there is any RFID tag in the plural RFID tags that is not interrogatable is performed by determining whether the total amount of the RFID tags that are interrogatable is equal to the amount of the plural RFID tags.

11. The method of claim 9, wherein each of the plural RFID tags is a smart tag.

12. The method of claim 9, wherein the shielding process further comprises the steps of:
selecting a RFID tag from the plural RFID tags that are situated inside the interrogation filed to be shielded;
performing an interrogation process upon the plural RFID tags inside the interrogation field for determining whether the amount of the RFID tags marked as interrogatable-grade tags is decreased; if so, identifying the shielded RFID tag to be one of the RFID tags being marked as the interrogatable-grade tags of the specific interrogation power; otherwise, identifying the shielded RFID tag to be one of the RFID tags being marked as the not-interrogatable-grade tags of the specific interrogation power; and
selecting another RFID tag from the plural RFID tags that are situated inside the interrogation filed to be shielded, and then repeating the previous determination process until the status of each and every one of the plural RFID tags are determined regarding to whether it is an interrogatable-grade tag of the specific interrogation power, or is a not-interrogatable-grade tag of the specific interrogation power.

13. The method of claim 9, wherein the shielding process further comprises the steps of:
selecting at least two RFID tags from the plural RFID tags that are situated inside the interrogation filed to be shielded;
performing an interrogation process upon the plural RFID tags inside the interrogation field for determining whether the amount of the RFID tags marked as interrogatable-grade tags is decreased; if so but the amount of the decreasing is smaller than the number of the RFID tags selected to be shielded, identifying each of the at least two shielded RFID tags to be either one of the RFID tags being marked as the interrogatable-grade tags of the specific interrogation power or one of the RFID tags being marked as the not-interrogatable-grade tags of the specific interrogation power by reducing the area corresponding to the shielding in a stepwise manner; and
selecting another at least two RFID tags from the plural RFID tags that are situated inside the interrogation filed to be shielded, and then repeating the previous determination process until the status of each and every one of the plural RFID tags are determined regarding to whether it is an interrogatable-grade tag of the specific interrogation power, or is a not-interrogatable-grade tag of the specific interrogation power.

14. The method of claim 9, wherein if the specific interrogation power applied before the repeating is the maximum interrogation power possible for testing the RFID tags, the RFID tags being marked as the interrogatable-grade tags of the specific interrogation power in the step (b) are being added selectively and respectively by another interrogatable marking corresponding to the changed specific interrogation power on those interrogatable RFID tags in the changed specific interrogation power, or by the another not-interrogatable marking corresponding to the changed specific interrogation power on those not interrogatable RFID tags in the changed specific interrogation power, both according to the determinations in the repeating.

15. The method of claim 9, wherein if the specific interrogation power applied before the repeating is the minimum interrogation power possible for testing the RFID tags, the RFID tags being marked as the not-interrogatable-grade tags of the specific interrogation power in the step (b) are being added selectively and respectively by another interrogatable marking corresponding to the changed specific distance on those interrogatable RFID tags in the changed specific distance, or by the another not-interrogatable marking corresponding to the changed specific interrogation power on those not interrogatable RFID tags in the changed specific interrogation power, both according to the determinations in the repeating.

16. The method of claim 9, wherein when each and every RFID tags within the interrogation field are determined to be interrogatable in the step (b), an evaluation is performed for determining whether the specific interrogation power is the maximum distance possible for testing the RFID tags.

17. A system for testing RFID tags, comprising:
a conveyer belt section, having a conveyer belt configured therein to be used for carrying a plurality of RFID tags;
an interrogation section, disposed at a side of the conveyer belt and capable of forming an interrogation field for reading data in the RFID tags of the plural RFID tags that are situated inside the interrogation field as they are being transported by the conveyer belt;
a position adjusting section, for adjusting a distance between the conveyer belt and the interrogation section as it is coupled to the interrogation section;
a shield section, for provide a specific shield to the plural RFID tags so as to define the amount of RFID tags capable of being interrogated by the interrogation section as the shield section is designed to be mobile for enabling the same to selectively shield at one RFID tag of the plural RFID tags; and
a moving section, capable of performing a displacement operation for enabling the shield section to move accordingly as it is coupled to the shield section.

18. The system of claim 17, wherein the plural RFID tag are disposed on the conveyer belt one after another in a line.

19. The system of claim 17, wherein the shield section is made of a material selected from the group consisting of: a metal, a wave dissipating material, a wave absorbing material, a wave reflecting material and a wave impeding material.

20. The system of claim 19, wherein the wave absorbing material is a material selected from the group consisting of: composites and polymers.

21. The system of claim 17, wherein each of the plural RFID tags is a smart tag.

22. The system of claim 17, further comprising:
a control unit, electrically connected with the interrogation section, the position adjusting section and the moving section, capable of controlling the position adjusting section to adjust the distance between the conveyer belt and the interrogation section and thus change the area capable of being interrogated by the interrogation section, while capable of basing upon the interrogation result of the interrogation section to determine whether the amount of the RFID tags in the interrogation field marked as interrogatable-grade tags is decreased so as to control the moving of the shield section for testing and grading the plural RFID tags.

23. The system of claim 17, wherein the conveyer belt is a roller-shaped belt or a rectangle-shaped belt.

24. A system for testing RFID tags, comprising:
a conveyer belt section, having a conveyer belt configured therein to be used for carrying a plurality of RFID tags;
an interrogation section with adjustable output interrogation power, disposed at a side of the conveyer belt and capable of forming an interrogation field according to its output interrogation power for enabling the RFID tags of the plural RFID tags, transported by the conveyer belt and thus entering into the interrogation field, to be interrogated;
a shield section, for provide a specific shield to the plural RFID tags so as to define the amount of RFID tags capable of being interrogated by the interrogation section as the shield section is designed to be mobile for enabling the same to selectively shield at one RFID tag of the plural RFID tags; and
a moving section, capable of performing a displacement operation for enabling the shield section to move accordingly as it is coupled to the shield section.

25. The system of claim 24, wherein the plural RFID tag are disposed on the conveyer belt one after another in a line.

26. The system of claim 24, wherein the shield section is made of a material selected from the group consisting of: a metal, a wave dissipating material, a wave absorbing material, a wave reflecting material and a wave impeding material.

27. The system of claim 26, wherein the wave absorbing material is a material selected from the group consisting of: composites and polymers.

28. The system of claim 24, wherein each of the plural RFID tags is a smart tag.

29. The system of claim 24, further comprising:
a control unit, electrically connected with the interrogation section and the moving section, capable of controlling the changing of the interrogation power of the interrogation section and thus change the area capable of being interrogated by the interrogation section, while capable of basing upon the interrogation result of the interrogation section to determine whether the amount of the RFID tags in the interrogation field marked as interrogatable-grade tags is decreased so as to control the moving of the shield section for testing and grading the plural RFID tags.

30. The system of claim 24, wherein the conveyer belt is a roller-shaped belt or a rectangle-shaped belt.
